(19) United States
(12) Patent Application Publication
(10) Pub. No.: US 2011/0220374 A1
(43) Pub. Date: Sep. 15, 2011

(54) BLADED TOOL

(76) Inventor: Daniel C. Martin, Raleigh, NC (US)

(21) Appl. No.: 13/043,777

(22) Filed: Mar. 9, 2011

Related U.S. Application Data
(60) Provisional application No. 61/312,136, filed on Mar. 9, 2010.

(51) Int. Cl. A01B 1/06; A01B 1/12; A01B 1/22; A01B 1/10

(52) U.S. Cl. 172/372; 172/371; 172/378

(57) ABSTRACT

The present disclosure is to a handled, bladed tool having a plurality of straight edges and at least four vertices formed by straight edges configured to perform various tasks. The tool comprises an angular configuration of the handle and the plane of the bladed tool face attached thereto.

### CROSS-REFERENCE TO RELATED APPLICATIONS

This application claims the benefit of Provisional Patent Application No. 61/312,136, filed on Mar. 9, 2010, which is hereby incorporated by reference herein in its entirety.

### TECHNICAL FIELD

This disclosure relates generally to a bladed tool and more particularly to a hoe type tool comprising a unique planar blade shape and including multiple vertices formed by straight edges configured to perform various utility functions, including gardening.

### BACKGROUND

Hoes and cultivating devices are commonly used when weeding and/or cultivating and are typically a long handled implements having a single straight edge blade fastened perpendicular to the longitudinal axis of the handle. These implements chop/plow action in the soil, for example, to break, loosen, and dig, usually by an extended-retracted arm motion of the operator with his and offers very poor leverage. The single straight cutting edge of this implement, oriented with its edge essentially par is very inefficient for cutting into the ground and further does not provide for translational motion of the blade edge in a direction generally parallel to the surface of the working area.

Agricultural implements of various kinds are known for use in manual operations for working the soil, cutting weeds, and their roots beneath the surface of the ground, pulverizing the upper crust of the earth for planting of seeds, furrowing the pulverized crust for planting, and hoeing or covering the planted seeds or fertilizer. Furthermore, various kinds of agricultural implements have been used which accomplish a combination of these agricultural operations.

### SUMMARY

The present disclosure is a handled, multiple edged planar bladed tool with multiple vertices formed by straight edges configured to perform various utilities and garden tasks. The tool is designed with an angled blade-to handle mounting arrangement that provides unique functionality for general utility and gardening tasks so that the user can comfortably kneel or stand upright while using. In one embodiment, the tool consists essentially of a handled planar blade comprising a plurality of straight edges, with multiple straight edges converging at multiple vertices about the blade, for example, forming a diamond-like shape. In another embodiment, the tool consists essentially of a handled planar blade comprising a plurality of straight edges, with the edges converging at multiple vertices about the blade in combination with a curved blade edge. In aspects of both embodiments, the straight edges are serrated.

Thus, in a first embodiment, a bladed tool is provided. The bladed tool comprising a handle of sufficient length, a connector coupling the handle at one end, a shaft coupled at one end to the opposite end of the connector, and a planar blade element having a top side and bottom side, the blade element perpendicularly coupled to the opposite end of the shaft. The blade element comprises at least four vertices defined by straight edges.

In a second aspect of the first embodiment, the planar blade element comprises 5 or more vertices.

In a third aspect of the first embodiment, the planar blade element comprises 6 or more vertices.

In a fourth aspect of the first embodiment, the planar blade element further comprises a curved edge or at least one edge that is serrated.

In a fifth aspect of the first embodiment, the planar blade has a diamond-like shape defined by straight edges.

In a sixth aspect of the first embodiment, a pair of the vertices of planar blade element are configured as wing-like elements projecting from the plane of the blade element.

In combination with any one of the previous embodiments of the first embodiment, the shaft comprises an arc angle, the arc defined by a angle formed by the perpendicularly coupled shaft and the longitudinal axis of the handle, the arc angle being about 40 degrees.

In a second embodiment, a bladed tool is provided. The bladed tool comprising a handle of sufficient length, a cylindrical ferrule coupling the handle at one end of the ferrule, a shaft coupled at the opposite end of the ferrule, and a planar diamond-like shaped blade element having a top side and bottom side perpendicularly coupled to the opposite end of the shaft. The outer edge of the blade element is sharpened along the top side, with the blade element comprising at least four vertices defined by straight edges. In one aspect, the tool is formed with the ferrule having a mounting hole receiving a spring pin threading the end of the shaft coupled to the ferrule and the handle end coupled to the ferrule, the ferrule being assembled on the handle, and fastened thereto, and the spring pin being threaded through the mounting hole to provide an arc angle of about 40 degrees. The arc angle is defined by an angle formed by the perpendicularly coupled shaft and the longitudinal axis of the handle, the arc angle being suitable for digging, for edging, weeding, digging holes, aerating and removing ice, caulk, gum, and paint from surfaces.

In a third embodiment, a method of working soil is provided. The method comprises contacting soil with the bladed tool of any one of previous embodiments above, where either: (i) the planar face of the blade element is positioned subterrainally and essentially parallel to the surface of the soil; or (ii) one of the vertices of the bladed tool is positioned subterrainally in the soil such that the plane of the blade element is pitched to one side. The bladed tool is then urged in a uni- or multi-directional manner in (i) or (ii).

In a fourth embodiment, a method of scraping impediments from a surface is provided. The method comprises contacting the surface with the bladed tool of any one of previous embodiments above, where the planar face of the blade element is positioned parallel to the surface, and the bladed tool is urged along the surface in a uni- or multi-directional manner.

### BRIEF DESCRIPTION OF THE DRAWINGS

FIG. 1 is a perspective view of a bladed tool embodiment disclosed and described herein;

FIG. 2 is a perspective view of a bladed tool embodiment disclosed and described herein;

FIG. 3 is a top elevation view of the bladed tool embodiment of FIG. 1;

FIG. 3A is an exploded view of the embodiment of FIG. 3;

FIG. 4 is a side elevation view of the bladed tool embodiment of FIG. 1;

FIG. 5 is an exploded view of the bladed tool embodiment of FIG. 1;

FIG. 6 is a perspective view of the bladed tool in use excavating soil;

FIG. 7 is a perspective view of the bladed tool in use aerating soil;

FIG. 8 is a perspective view of the bladed tool in use on a horizontal surface for scraping, de-icing, de-caulking, etc;

FIG. 9 is a perspective view of a bladed tool embodiment having at least one edge that is serrated disclosed and described herein; and

FIG. 9A is an exploded view of the embodiment of FIG. 9;

FIG. 10 is a perspective view of a serrated bladed tool embodiment disclosed and described herein.

### DETAILED DESCRIPTION

Disclosed and described is a planar bladed tool comprising a unique blade shape and including multiple vertices formed by straight edges configured to perform various utility functions, including gardening.

The blade element of the instant bladed tool is preferably formed of durable, rigid, material such as metal, metal alloys, ceramic, carbide, nitrides, or combinations thereof. The bladed tool may be adapted for interchanging blades, or may be specific for a single size blade, for example, a blade of about of about 4.5″×2.5″ may be used for small flower beds and yards, while a 7″×3″ blade element may be used for typical residential yards and gardens. Other sized blade elements can be used. A plurality of individual blade elements can be packaged as a combination or kit with one or more handles.

The blade element is provided with a plurality of sharp, perimeter edges, with at least four or more vertices formed by straight edges. Tapering the top surface edge of the blade element about the perimeter thereof provides a sharp cutting surface with the bottom surface being flat and the top surface being tapered generally downwardly to form the sharp perimeter edge. The edge is generally beveled, typically to about 0.25″ to hold the edge and to provide certain attributes during use. The edge can be designed for sharpening by hand file or grinding wheel. In another aspect, the blade element can be designed for predetermined obsolescence, e.g., as a disposable tool.

Because of the predetermined angular relationship of the blade element face, shaft and handle of the instant bladed tool, when a force is applied to the top face of blade element, the sharp edge can be leveraged under a surface or an impediment upon a surface. Alternatively, the sharpened perimeter edge can be guided downwardly at a shallow angle for access to a predetermined depth below the surface to be worked generally parallel to the surface, as further discussed below.

In another aspect, the blade element comprises a plurality of straight edges, for example at least three straight edges, at least four straight edges, at least five straight edges, at least six straight edges, or more. In a preferred aspect, three or more pairs of blade edges converge to a sharp edge point or a rounded edge. In a more preferred aspect, six pairs of blade edges converge to a sharp edge point or a rounded edge. In another aspect, four or more pairs of blade edges converge to a sharp edge point or a rounded edges, in combination with a curved edge. In another aspect, one or more of the vertices of the blade element can be configured to project upwardly and/or downwardly from the plane of the blade element (e.g., wing-like elements) for improved aeration. The wing-like elements can be configured at opposite corner vertices, for example. The length and width of the wing-like elements can be configured such that aeration performance is optimized.

The blade element is configured to adapt to a connecting means for attachment to a handle. Thus, in one aspect, about ¼″ to about ⅝″ diameter rod or shaft of up to about 14″ or more of total length that can be welded to the approximate center of the blade element at a ninety degree angle and then arced at an angle thereafter. In one aspect, the section of rod projecting perpendicular from the face of the blade element up to the arc is from about 1″ to about 4″ in length. In a preferred aspect, the section of rod measured from the face of the blade element up to the arc is about 2″ to about 3″ in length. The section of the rod measured from the arc up to the handle is about 4″ to about 10″. The diameter of the rod is between about ⅜″ diameter to about ½″ diameter. Other diameters can be used and variable or tapered diameters about the rod can be used.

The rod is adaptable to a connection means, such as a cylindrical joint or ferrule, for securing the rod and blade element to a handle at a predetermined angle relative to the longitudinal axis of the handle. About 1″-2″ of the rod above the arc remains exposed from the ferrule. Other connectors or means, such as sleeves, set screws, welds, locking nuts, threaded holes & bosses, bolts, adhesives and the like can be used alone or in combination to connect the blade and shaft to the handle. The handle can be formed of wood, metal, plastic, fiberglass or similar material. The handle can be of a fixed length or of an adjustable length so that the user can work either from a standing or kneeling position. The handle can be configured with ergonomic grips and related features for user comfort and control.

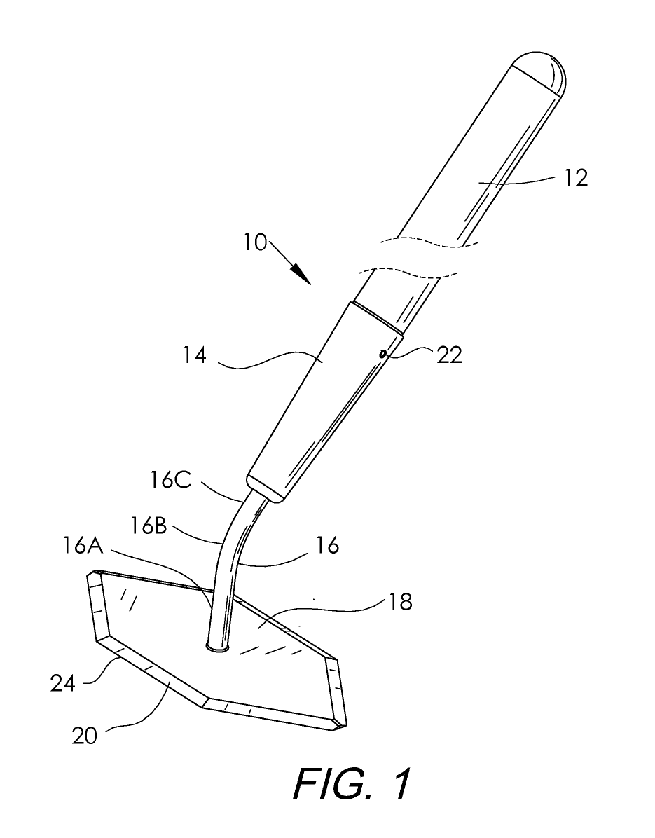

Referring now to the drawings, the reference numerals 10, 70, and 90 referring generally to the bladed tool embodiments and aspects of this present disclosure. Thus, as depicted in FIG. 1, bladed tool 10 includes handle 12 formed of wood, metal, plastic, fiberglass or similar material, ferrule 14 and shaft 16 terminating at blade element 18. Blade element 18 comprises a plurality of edges 24 with taper 20 of generally “diamond-like shape”. The diamond-like shape of the blade element allows for use in close proximity to items in the work area with improved user control. Shaft 16 comprises three sections, first straight section 16A projecting vertically from blade element face 18, arced section 16B, and second straight section 16C.

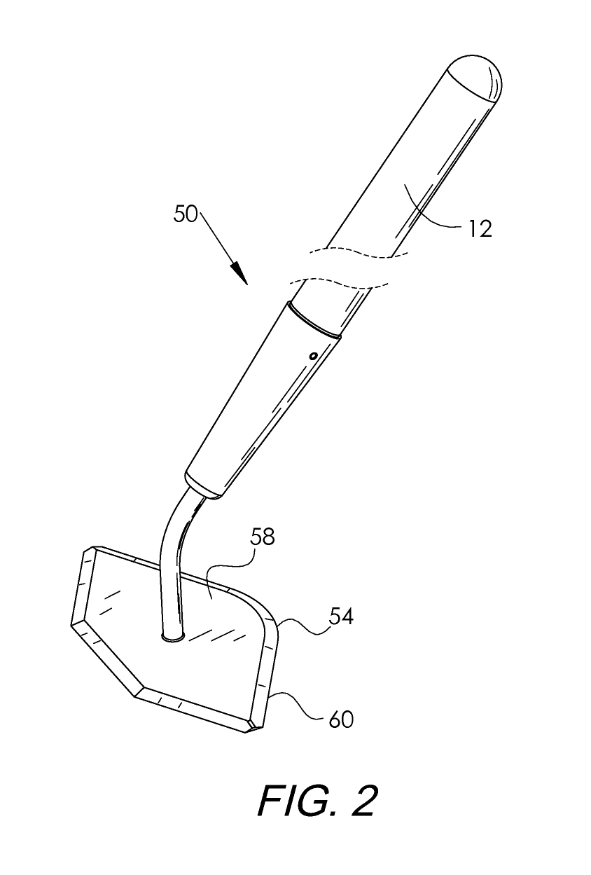

Referring now to FIG. 2, bladed tool 50 is configured with an alternate blade element 58 shape is depicted in which a plurality of vertices formed by straight edges together with a curved edge 54 of taper 60 is provided, all other aspects of the bladed tool being essentially the same. Other configurations of vertices formed by straight edges in combination with curved edges can be used and are encompassed herein.

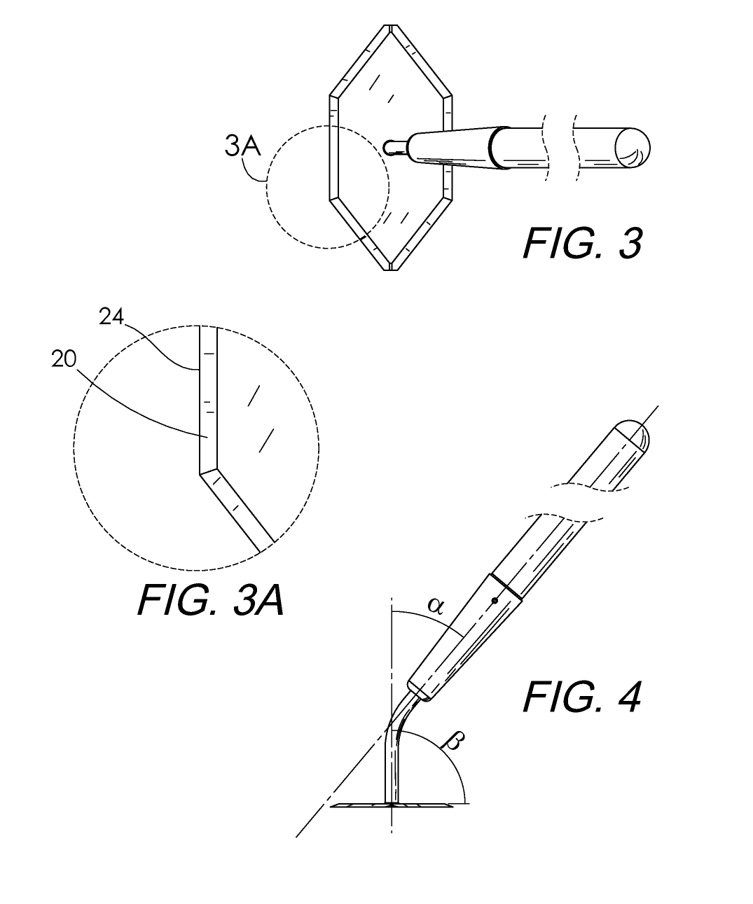

FIG. 3 depicts a top elevation view of tool 10 indicating section 3A of blade element. FIG. 3A depicts exploded view 3A of sharpened edges 24 with taper 20 on the top surface of blade element. Edge 24 can be designed for sharpening by hand or by tool. In another aspect, the blade element can be designed for predetermined obsolescence, e.g., as a disposable. The edge 24 is generally beveled, typically to about 0.25″ taper, or other suitable length to hold an edge and to provide certain attributes during use.

With reference to FIG. 4, the angular relationships of the shaft arc alpha, beta relative to the face of the blade element and the longitudinal axis of the handle is depicted. In one aspect, the arc angular relationship beta of the instant blade element 18 with shaft 16 is about 90 degrees, preferably with a small tolerance of less than 0.5 degrees. Shaft angle alpha, defined as the angle made by the longitudinal axis of the handle and the perpendicular from the face of blade element 18 is about 40 degrees. In one aspect, alpha excludes angles less than 36 degrees. In another aspect, alpha excludes angles greater than 54 degrees. It is generally observed that alpha angles of less than 36 degrees and/or greater than 54 degrees greatly diminish the user comfort during use of the instant bladed tool, and thus, the effectiveness of one or more of its functional attributes. Moreover, the curvature, length and angularity of the shaft provides for improved functionality over other tools. For example, when held in a normal, natural manner, with the top surface edge of the blade element 18 generally parallel to the area to be worked, and with the bottom surface being essentially flat and the top surface being having a bevel shaped downwardly around the top surface, a perimeter cutting surface with a sharp edge is provided. As a first force is applied to the top of blade element 18 via the perpendicular shaft attached thereto, and a second force applied causing the blade element to traverse forward and/or backward away and towards the user, respectively, the sharp perimeter edge can penetrate the ground surface to a predetermined depth up to about the length of the straight section of the shaft. The angular relationship alpha of the handle with the face of the blade element allows the sharpened perimeter edge to be maintained in a general parallel orientation during application of the second force back/forth. Thus, any undesirable downwardly, and deeper penetration of the blade element into the surface to be worked is reduced or avoided.

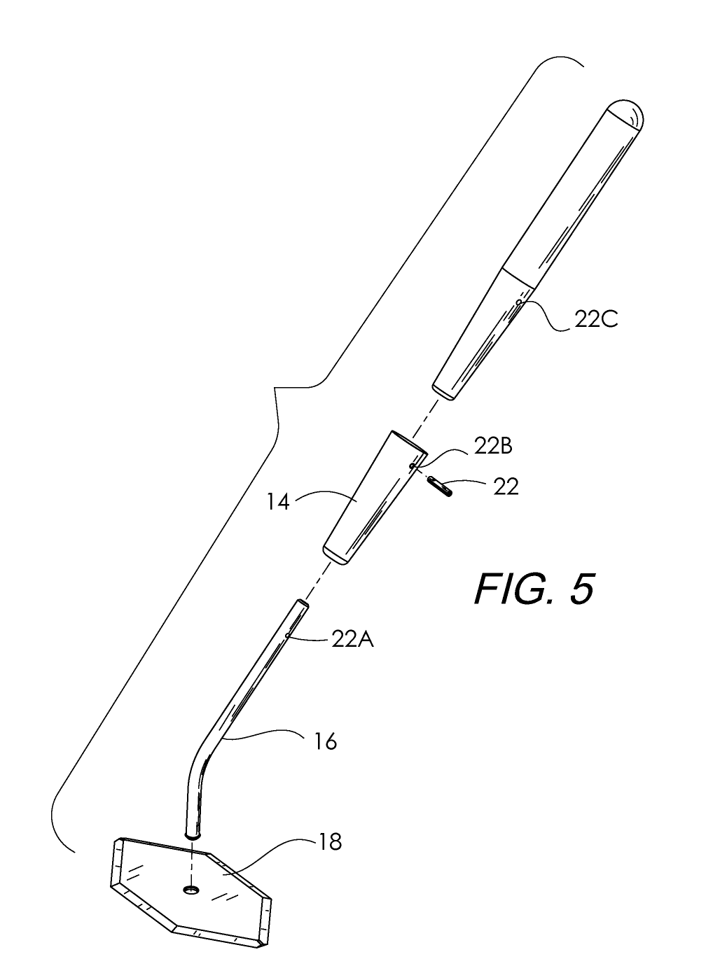

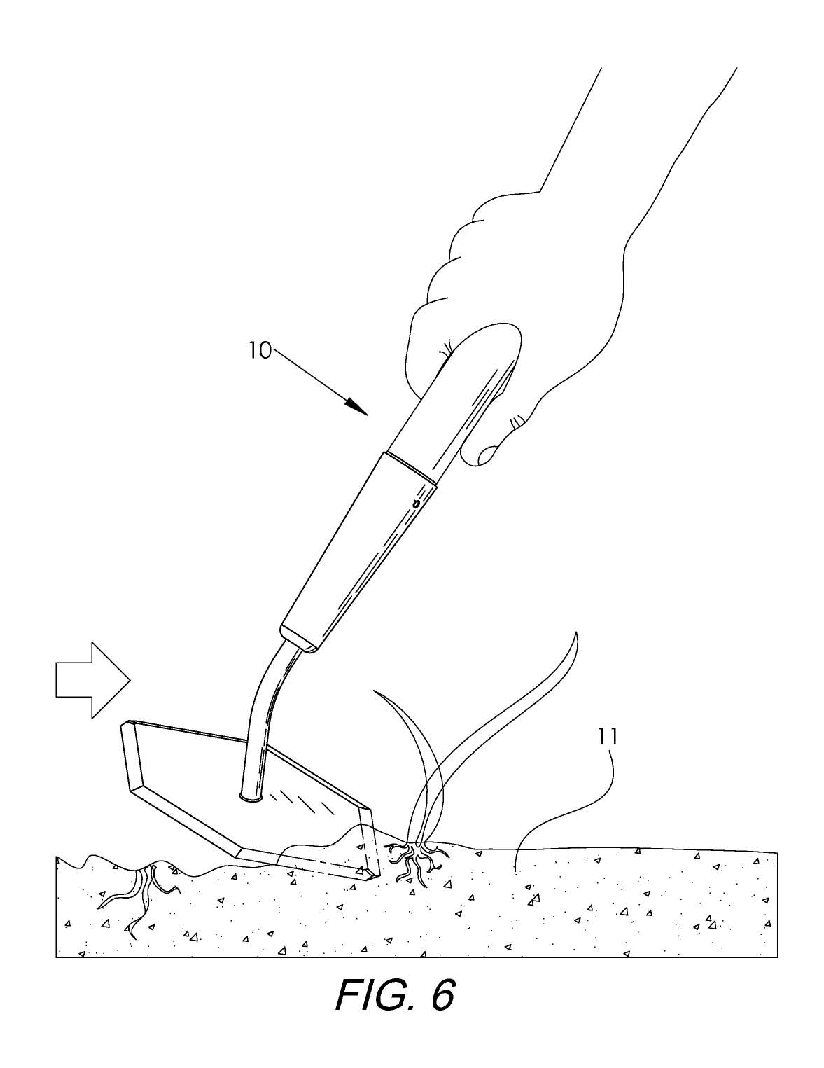

Referring now to FIG. 5, an exploded view of the bladed tool depicts blade element 18 connected to shaft 16. Shaft 16 is received by tapered ferrule 14 at one end thereof, with corresponding tapered end of handle being received by the opposite end of the ferrule. Mounting holes receives spring pin 22 for securing the shaft, ferrule and handle. Pre-boring a receiving hole 22C in the tapered handle section, in ferrule 22B, and shaft 22A to a diameter slightly smaller than that of the spring pin, is generally preferred. Other methods of securing the shaft to the handle, such as sleeves, set screws, welds, locking nuts, threaded holes & bosses, bolts, adhesives and the like can be used, alone or in combination.

As depicted in FIG. 6, the instant blade tool can be effectively used to plow, trench, cultivate, and/or furrow soil 11 or other material. To plow or trench, the user can rotate the handle of blade tool 10 such that one of the vertices is positioned into the soil, which by virtue of the relationship of the shaft and angles alpha/beta, the face or plane of blade element 18 is pitched to one side of the user, allowing for the plowed or trenched soil to be displaced to that side of the blade element face. The face or plane of blade element 18 being pitched relative to the handle axis provides for the worked material, e.g., soil, to be displaced such that it does not collect in front of the face or plane causing resistance. The instant bladed tool maintains a predetermined depth of plow, trench, cultivation, or aeration, as the user traverses the blade across the soil. When the blade element 18 is turned over such that a long straight edge of the blade element is pulled across the raised furrow, at least a portion of the soil on either side of the furrow is urged to cover over the furrow.

The user is able to work in a normal manner to accomplish this effect, without the need to manually adjust the instant tool or make unnatural motions during use of the tool. When used in this configuration, e.g., one of the convergent edges of the blade element 18 angled downward and the blade element face slightly pitched away from the user, the instant bladed tool also provides for an effective digging tool, optimizing the pitched, sharp blade element face, angle of entry, and push/pull/up/down effort of the user. Thus, instant bladed tool 10, can be utilized for heavily overgrown areas, in hard, compacted soil, or for chopping ice. As a result, the tool is more comfortable to the user and more efficiently utilized.

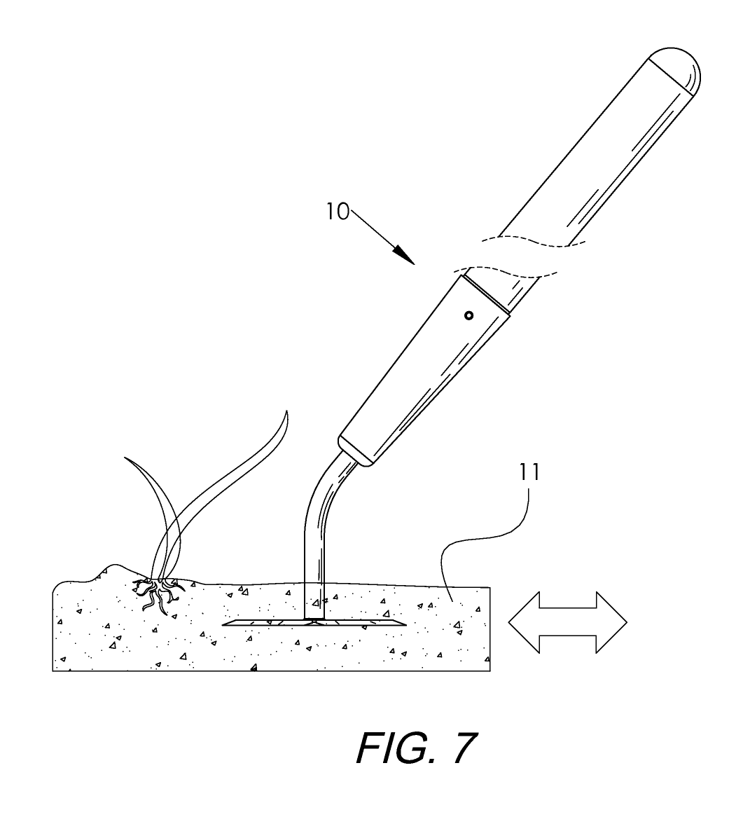

Referring now to FIG. 7, the instant blade tool 10 can be deployed for effective aeration of soil 11. As shown, the blade element can be inserted to a predetermined depth in the soil with the blade element generally parallel to the surface above the face of the blade element. Using a generally back and forth motion as indicated by the arrow in FIG. 7, the soil can be effectively aerated. The predetermined depth of the blade element can be at least partially controlled by the choice of length for the shaft projecting essentially perpendicular from the blade element face. Because of the edge shape design, the instant bladed tool is especially useful for working close to growing plants and/or around other objects in the soil. The position of the shaft in the blade element face and well as the curvature of the shaft provides for facile translation of the blade element through the soil and in close proximity to objects therein, without substantially obstructing the motion thereof.

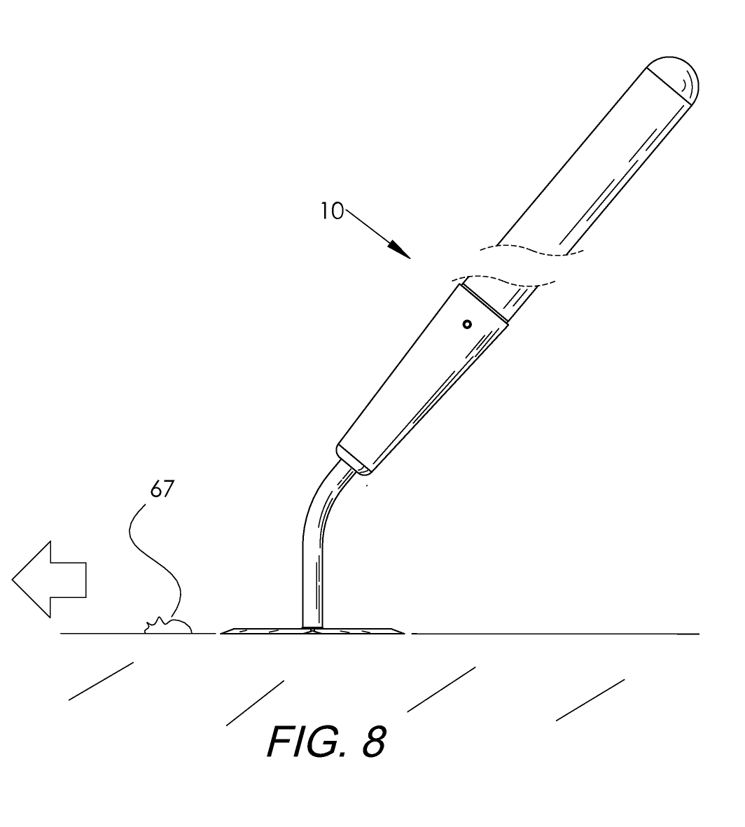

Referring to FIG. 8, the instant tool 10 is depicted in use on top of a surface, whereby a leading edge of the blade element 18 is urged under raised impediment 67 with a minimal amount of user-applied force. In addition to the removal of raised impediments, the instant tool is effective for removing paint, glue, gum, caulk, wallpaper, and ice. The user can position the edge of the blade element 18 near the edge of the raised impediment on the surface, and by leveraging the edge underneath it, cause the impediment to be released. In another aspect, one of the convergent edges of the blade element can be used as a penetrating point for causing an opening in the ice. The beveled edge can then be placed under a portion of the ice to loosen and/or remove sections thereof. Likewise, one straight edged section of the blade element 18 can be used as a cutting implement, for example to cut sod or other plant bedding into a predetermined section suitable for removal. The blade element 18 can then positioned flatly under the cut section and lifted in an upright motion to raise the section from the ground.

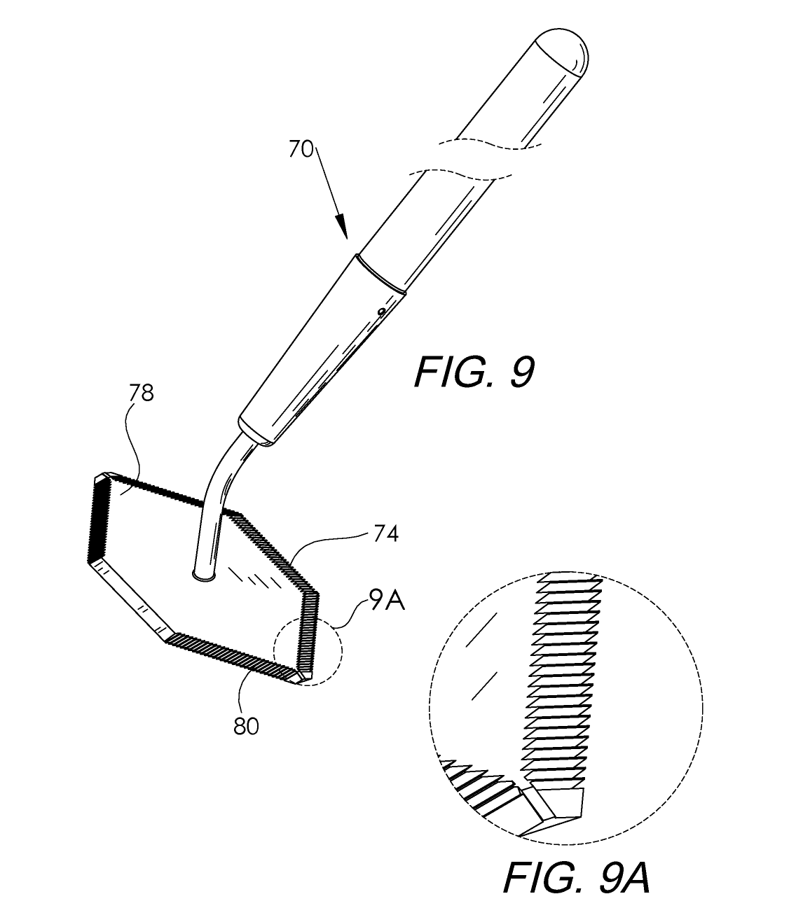

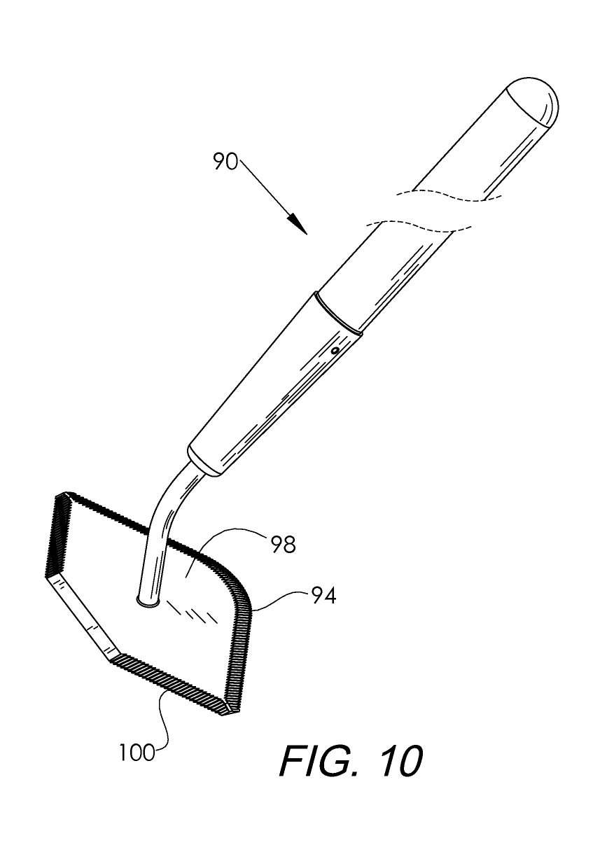

Referring now collectively to FIGS. 9, 9A, and 10, various embodiments and corresponding aspects are shown. Thus, in FIG. 9, diamond-like bladed tool 70 comprises blade element 78 with at least one edge 74 being dentated or toothed, e.g., serrated blade 80, indicating exploded view section 9A as shown in FIG. 9A. Likewise, tool 90 with blade element 98 comprising both straight and curved edged 94 blade has dentated or toothed, e.g., serrated edge 100. A single pattern or combination of patterns of serration can be employed, such as wavy, scalloped or saw-like patterns.

It will be realized that various changes may be made to the specific embodiment shown and described without departing from the principles and spirit of the present disclosure.

What is claimed is:

1. A bladed tool comprising:
an handle of sufficient length;
a connector coupling the handle at one end;
a shaft coupled at one end to the opposite end of the connector; and
a planar blade element having a top side and bottom side, the blade element perpendicularly coupled to the opposite end of the shaft, the blade element comprising at least four vertices defined by straight edges.

2. The bladed tool of claim 1, wherein the planar blade element comprises 5 or more vertices.

3. The bladed tool of claim 1, wherein the planar blade element comprises 6 or more vertices.

4. The bladed tool of claim 1, wherein the planar blade element further comprises a curved edge.

5. The bladed tool of claim 1, wherein the planar blade has a diamond-like shape defined by straight edges.

6. The bladed tool of claim 1, wherein the planar blade has at least one edge that is serrated.

7. The bladed tool of claim 1, wherein the shaft comprises an arc angle, the arc defined by an angle formed by the perpendicularly coupled shaft and the longitudinal axis of the handle, the arc angle being about 40 degrees.

8. The bladed tool of claim 1, wherein the handle is extendable or adjustable.

9. The bladed tool of claim 1, wherein a pair of the vertices of the planar blade element are configured as wing-like elements projecting from the plane of the blade element.

10. A bladed tool comprising:
an handle of sufficient length;
a cylindrical ferrule coupling the handle at one end of the ferrule;
a shaft coupled at the opposite end of the ferrule; and
a planar diamond-like shaped blade element having a top side and bottom side, the outer edge of the blade element being sharpened along the top side, the blade element being perpendicularly coupled to the opposite end of the shaft, the blade element comprising at least four vertices defined by straight edges,
formed with the ferrule having a mounting hole receiving a spring pin threading the end of the shaft coupled to the ferrule and the handle end coupled to the ferrule, the ferrule being assembled on the handle, and fastened thereto, and the spring pin being threaded through the mounting hole to provide an arc angle of about 40 degrees,
wherein the arc angle is defined by a angle formed by the perpendicularly coupled shaft and the longitudinal axis of the handle, the arc angle being suitable for digging, for edging, weeding, digging holes, aerating and removing ice, caulk, gum, and paint from surfaces.

11. A method of working soil comprising contacting soil comprising:
providing a bladed tool comprising:
an handle of sufficient length;
a connector coupling the handle at one end;
a shaft coupled at one end to the opposite end of the connector; and
a planar blade element having a top side and bottom side, the blade element perpendicularly coupled to the opposite end of the shaft, the blade element comprising at least four vertices defined by straight edges, wherein either: (i) the planar face of the blade element is positioned subterrainally and essentially parallel to the surface of the soil; or (ii) one of the vertices of the bladed tool is positioned subterrainally in the soil such that the plane of the blade element is pitched to one side; and
urging the bladed tool in a uni- or multi-directional manner while positioned in (i) or (ii).

12. The method of claim 11, wherein the planar blade element comprises 5 or more vertices.

13. The method of claim 11, wherein the planar blade element comprises 6 or more vertices.

14. The method of claim 11, wherein the planar blade has a diamond-like shape defined by straight edges.

15. The method of claim 11, wherein the shaft comprises an arc angle, the arc defined by an angle formed by the perpendicularly coupled shaft and the longitudinal axis of the handle, the arc angle being about 40 degrees.

16. A method of scraping impediment from a surface comprising
providing a bladed tool comprising:
an handle of sufficient length;
a connector coupling the handle at one end;
a shaft coupled at one end to the opposite end of the connector; and
a planar blade element having a top side and bottom side, the blade element perpendicularly coupled to the opposite end of the shaft, the blade element comprising at least four vertices defined by straight edges; wherein the planar face of the blade element is positioned parallel to the surface;
contacting a surface having impediment with the bladed tool; and
urging the bladed tool along the surface in a uni- or multi-directional manner.

17. The method of claim 16, wherein the planar blade element comprises 5 or more vertices.

18. The method of claim 16, wherein the planar blade element comprises 6 or more vertices.

19. The method of claim 16, wherein the planar blade has a diamond-like shape defined by straight edges.

20. The method of claim 16, wherein the shaft comprises an arc angle, the arc defined by an angle formed by the perpendicularly coupled shaft and the longitudinal axis of the handle, the arc angle being about 40 degrees.
